(19) United States
(12) Patent Application Publication
(10) Pub. No.: US 2011/0277585 A1
(43) Pub. Date: Nov. 17, 2011

(54) STROKE-CONTROLLING DEVICE AND METHOD

(75) Inventors: Dennis E. Kroll, League City, TX (US); Paul Madero, Cypress, TX (US); Justin P. Vinson, Houston, TX (US); Kevin William Clark, Montgomery, TX (US)

(73) Assignee: BAKER HUGHES INCORPORATED, Houston, TX (US)

(21) Appl. No.: 12/779,326

(22) Filed: May 13, 2010

(51) Int. Cl. G05G 5/04

(52) U.S. Cl. 74/527

(57) ABSTRACT

A stroke-controlling device includes a first body having a first surface and a second body movably engaged with the first body having a second surface. A dimension between the first surface and the second surface is configured to engage a tool. And at least one dog is in operable communication with the first body and the second body to maintain the dimension at a first value when in a first position and to limit reduction of the dimension to a second value when in to a second position.

### BACKGROUND

Devices, such as tubular actuators, for example, typically stroke one member in relation to another member. Control of the stroke dimensions often depends upon the motive force employed by the actuator, such as, hydraulics, pneumatics, and electric motors to name a few. These systems require complicated input control systems to control strokes of the actuator. Additionally, maintaining the actuator at a desired position can be effected by leaks in the control lines, for example. New devices and methods of controlling stroke that overcome the foregoing issues are therefore well received in industry.

### BRIEF DESCRIPTION

Disclosed herein is a stroke-controlling device including a first body having a first surface and a second body movably engaged with the first body having a second surface. A dimension between the first surface and the second surface is configured to engage a tool. And at least one dog is in operable communication with the first body and the second body to maintain the dimension at a first value when in a first position and to limit reduction of the dimension to a second value when in a second position.

Further disclosed is a method of controlling stroke of a device. The method includes defining a first dimension between a first surface of a first body and a second surface of a second body by engagement of at least one dog with both the first body and the second body in a first position, and defining a second dimension is between the first surface and the second surface by engagement of the at least one dog with both the first body and the second body while in a second position.

### BRIEF DESCRIPTION OF THE DRAWINGS

The following descriptions should not be considered limiting in any way. With reference to the accompanying drawings, like elements are numbered alike:

FIGS. 1A-1D depict cross sectional views of adjacent portions of a stroke controlling device disclosed herein;

FIG. 2 depicts a partial magnified cross sectional view a portion of the stroke-controlling device of FIGS. 1A-1D with dogs in a first position;

FIG. 3 depicts a partial magnified cross sectional view of the portion of the stroke-controlling device of FIG. 2 with dogs in a second position; and

FIG. 4 depicts an alternate embodiment of the dogs disclosed herein.

### DETAILED DESCRIPTION

A detailed description of one or more embodiments of the disclosed apparatus and method are presented herein by way of exemplification and not limitation with reference to the Figures.

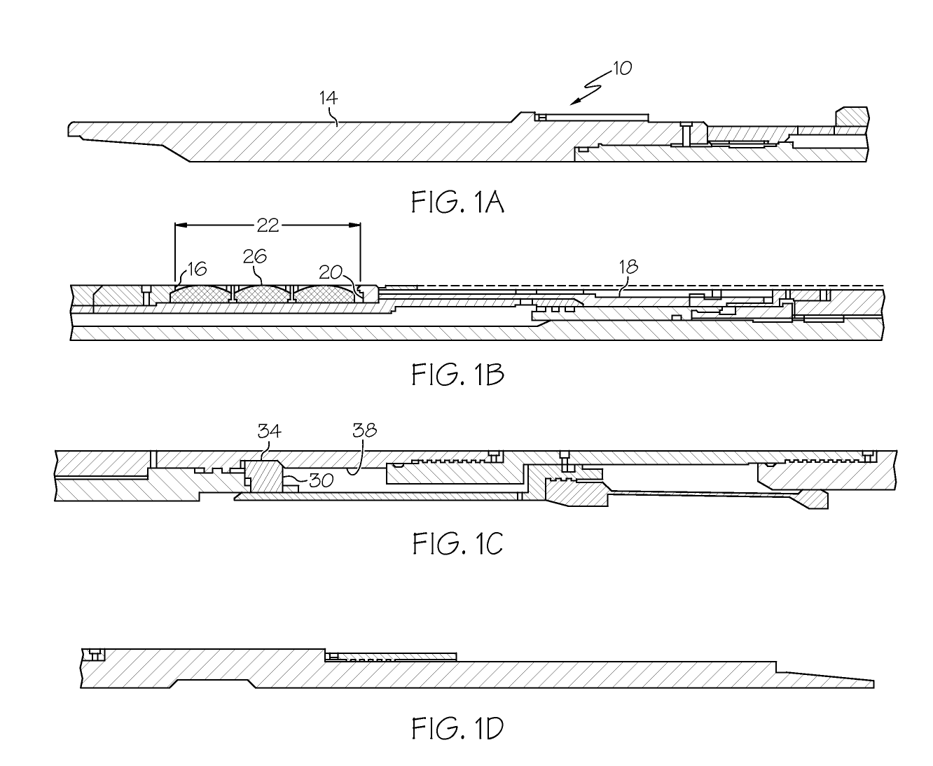

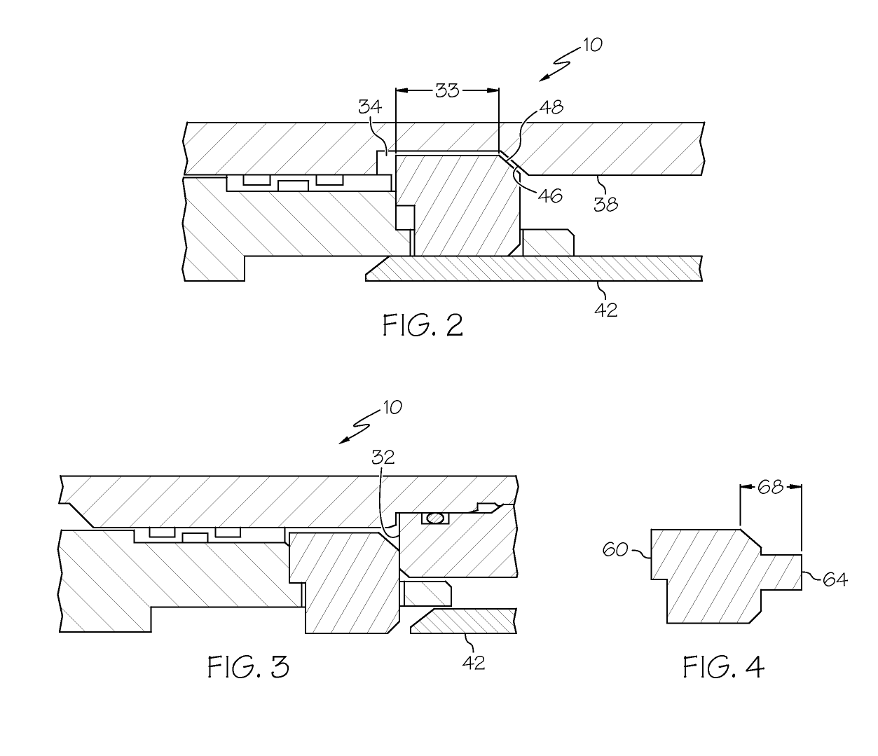

Referring to FIGS. 1A-1D, 2 and 3, an embodiment of a stroke-controlling device disclosed herein is illustrated generally at 10. The stroke-controlling device 10 in this embodiment includes, a first body 14, shown as a tubular assembly, having a first surface 16, and a second body 18, also shown as a tubular assembly, having a second surface 20, and the second body 18 is movable relative to the first body 14 in a longitudinal direction. The first surface 16 and the second surface 20 define a dimension 22 therebetween configured to engage a tool 26, shown herein as a compressible seal. At least one dog 30, with a plurality of the dogs being employed herein (even though only one is viewable in the figures), is in operable communication with both the first body 14 and the second body 18 and is movable between at least a first position (as shown in FIGS. 1C and 2), and a second position (as shown in FIG. 3). A first value of the dimension 22 is maintained by the at least one dog 30 being in the first position such that a load can be supported through the first body 14, the dogs 30 and the second body 18. The dimension 22 is reducible to a second value in response to the dogs 30 being in the second position thereby allowing a third surface 32 on the second body 18 to abut the dogs 30. The second value of the dimension 22 is thereby in part determined by a longitudinal dimension 33 of the dogs 30. As such, the dogs 30 can be used to establish a minimum value achievable for the second value of the dimension 22. Additionally, by altering the longitudinal dimension 33 of the dogs 30 the second value of the dimension 22 can be readily changed.

The first position of the dogs 30 is defined as being when the dogs 30 are radially engaged in a recess 34, shown herein as an annular recess, in an inner surface 38 of the second body 18. A sleeve 42, while in a first location (as shown in FIGS. 1C and 2), maintains the dogs 30 in the first position by preventing them from moving radially inwardly to the second position. In contrast, when the sleeve 42 is in a second location (as shown in FIG. 3), the dogs 30 are free to move radially inwardly to the second position in response to, for example, a longitudinal urging between ramped surfaces 46 and 48 on the second body 18 and the dogs 30, respectively. The sleeve 42 may be longitudinally movably engaged with the second body 18 with detents (not shown) to the sleeve 42 into one of the first location and the second location until deliberately moved therefrom.

The foregoing structure controls a stroke of the second body 18 in relation to the first body 14 and thereby controls the value of the dimension 22. The tool 26, engaged within the dimension 22 can be selected to actuate in response to the dimension 22 being changed from the first value to the second value. In this embodiment, for example, wherein the tool 26 is a compressible seal, the first value of the dimension 22 may maintain the tool 26 in the non-actuated condition while the second value assures that the tool 26 has fully actuated while preventing over compression, which could lead to failure of the tool 26.

Referring to FIG. 4, in an alternate embodiment, dogs 60 have a protrusion 64 that defines an offset dimension 68. A unique stroke length defined as the difference between the first value and the second value of the dimension 22 can be selected by simply selecting a unique dog 60 having a unique value for the offset dimension 68.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A stroke-controlling device comprising:
a first body having a first surface;
a second body movably engaged with the first body having a second surface, a dimension between the first surface and the second surface being configured to engage a tool; and
at least one dog in operable communication with the first body and the second body to maintain the dimension at a first value in response to being in a first position and to limit reduction of the dimension beyond a second value in response to being in a second position.

2. The stroke-controlling device of claim 1, wherein at least one of the first body and the second body is tubular.

3. The stroke-controlling device of claim 1, wherein the movable engagement between the first body and the second body is longitudinal.

4. The stroke-controlling device of claim 1, wherein the first surface and the second surface are oriented radially.

5. The stroke-controlling device of claim 1, wherein the at least one dog engages a recess of the second body when in the first position and disengages with the recess when in the second position.

6. The stroke-controlling device of claim 1, further comprising a sleeve movable relative to the at least one dog between a first location and a second location, that maintains the at least one dog in the first position when in the first location and allows the at least one dog to move to the second position when in the second location.

7. The stroke-controlling device of claim 6, wherein the sleeve is movably engaged with the second body.

8. The stroke-controlling device of claim 6, wherein the sleeve is longitudinally movable relative to the at least one dog.

9. The stroke-controlling device of claim 6, wherein the sleeve prevents radial movement of the at least one dog when in the first location.

10. The stroke-controlling device of claim 1, wherein the second body has a third surface configured to contact the at least one dog thereby defining the second value of the dimension.

11. The stroke-controlling device of claim 1, wherein a dimension of the at least one dog defines the second value.

12. The stroke-controlling device of claim 11, wherein the dimension of the at least one dog is a longitudinal dimension.

13. The stroke-controlling device of claim 1, wherein the tool is a seal settable by longitudinally compression thereof.

14. The stroke-controlling device of claim 13, wherein the second value prevents the seal from being overly compressed.

15. A method of controlling stroke of a device comprising:
defining a first dimension between a first surface of a first body and a second surface of a second body by engagement of at least one dog with both the first body and the second body being in a first position; and
defining a second dimension between the first surface and the second surface by engagement of the at least one dog with both the first body and the second body while being in a second position.

16. The method of controlling stroke of a device of claim 15, further comprising defining a stroke of the device as the difference between the first dimension and the second dimension.

17. The method of controlling stroke of a device of claim 16, further comprising altering the stroke by changing a longitudinal dimension of the at least one dog.

18. The method of controlling stroke of a device of claim 15, further comprising moving the at least one dog from the first position to the second position.

19. The method of controlling stroke of a device of claim 15, further comprising maintaining the at least one dog in the first position with a sleeve engaged therewith.

20. The method of controlling stroke of a device of claim 15, further comprising moving a sleeve relative to the at least one dog thereby enabling repositioning of the at least one dog from the first position to the second position.

21. The method of controlling stroke of a device of claim 15, further comprising supporting load through the first body, the second body and the at least one dog while the at least one dog is in the first position.

22. The method of controlling stroke of a device of claim 15, further comprising supporting load through the first body, the second body and the at least one dog while the at least one dog is in the second position.
